(19) United States
(12) Patent Application Publication
(10) Pub. No.: US 2014/0290068 A1
(43) Pub. Date: Oct. 2, 2014

(54) MULTI SLICE PIZZA CUTTER

(71) Applicant: Robert Karl Tarquinio, Santa Monica, CA (US)

(72) Inventor: Robert Karl Tarquinio, Santa Monica, CA (US)

(21) Appl. No.: 13/852,651

(22) Filed: Mar. 28, 2013

(51) Int. Cl. A21C 15/04

(52) U.S. Cl. CPC A21C 15/04
USPC 30/114

(57) ABSTRACT

I claim to have invented a tool to cut multiple pizza slices simultaneously in order to reduce pizza slice cutting time.

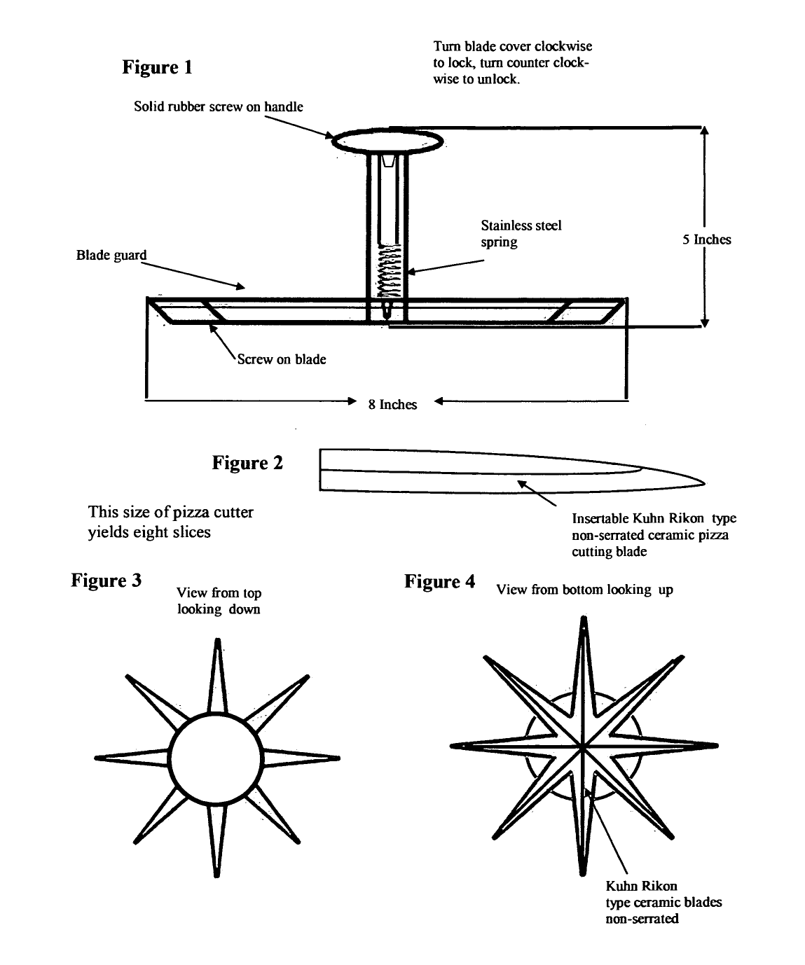

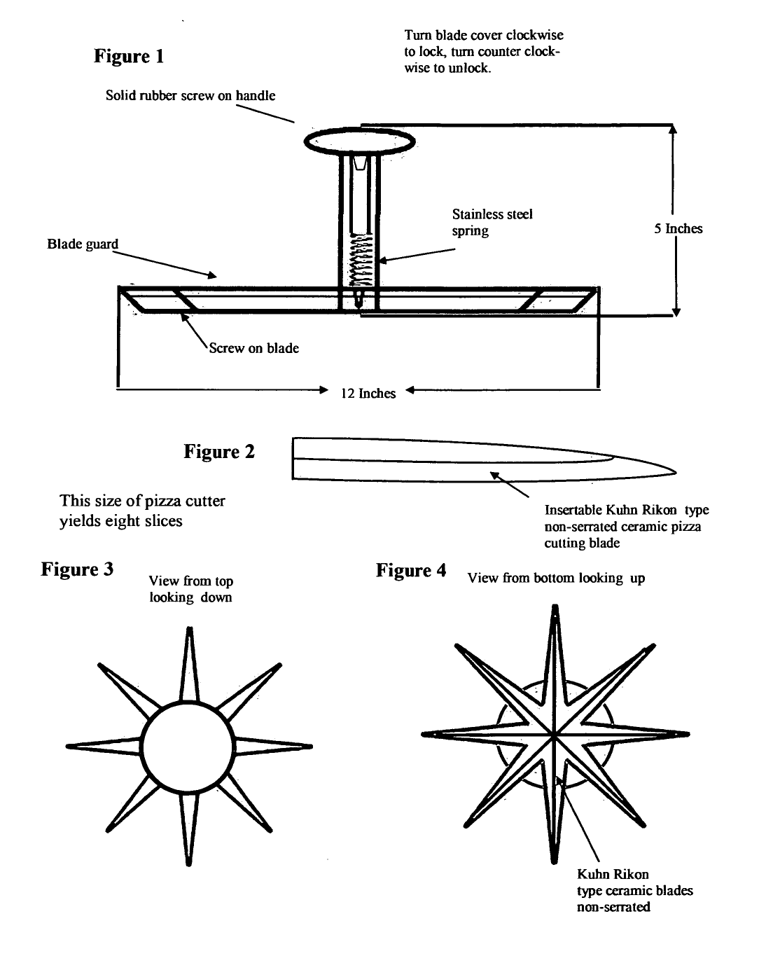

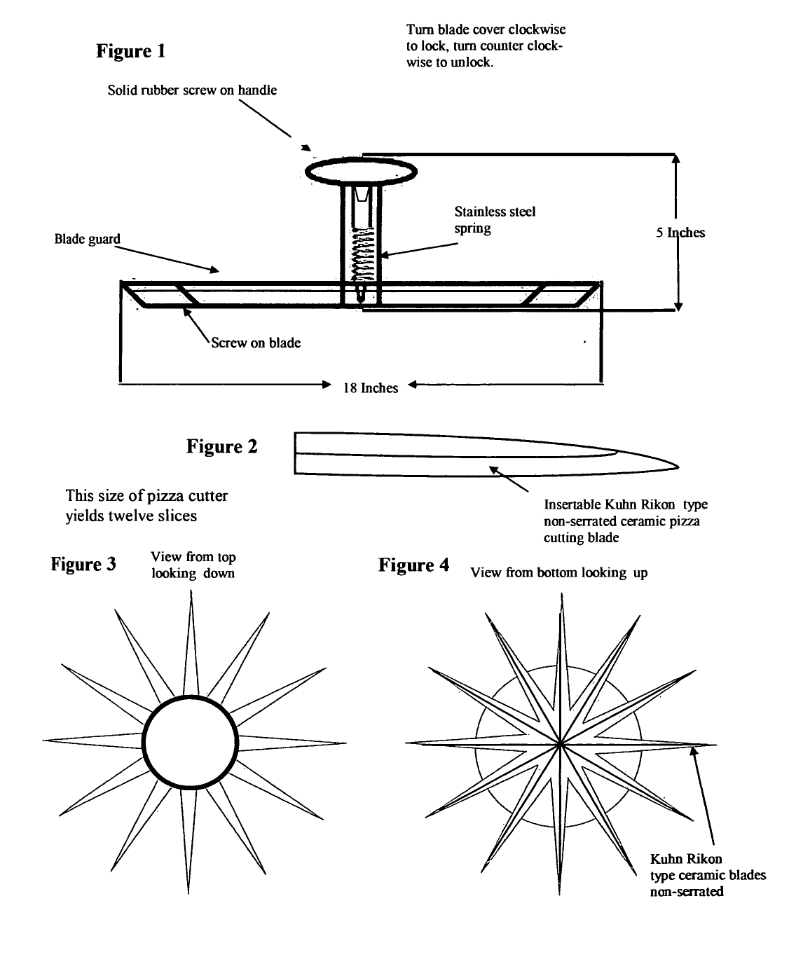

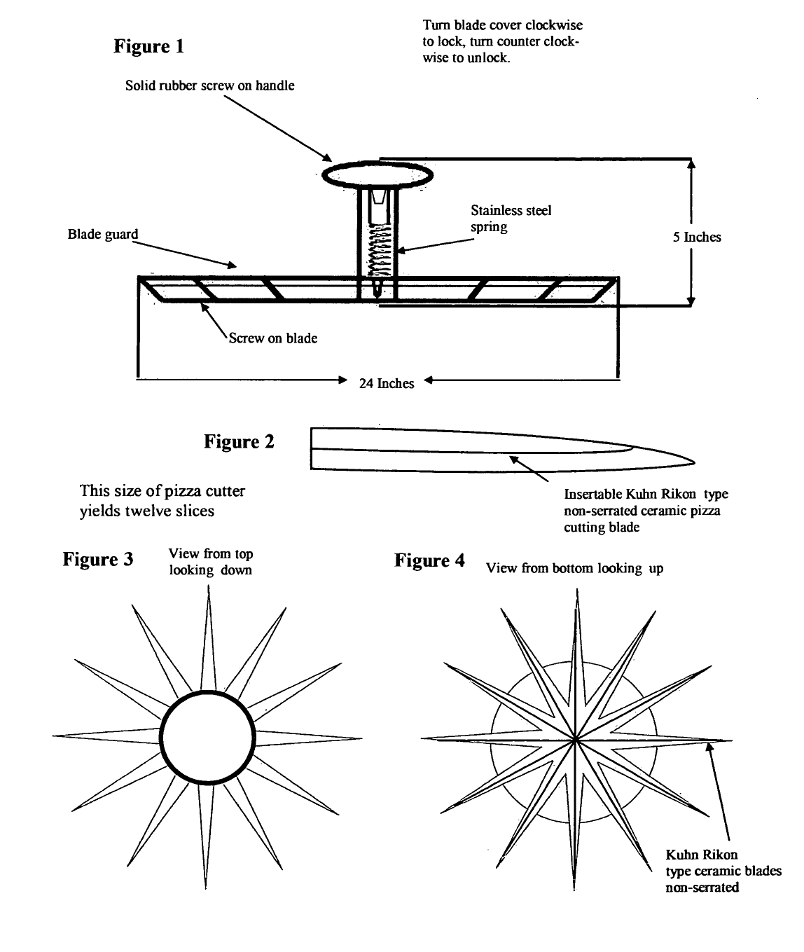

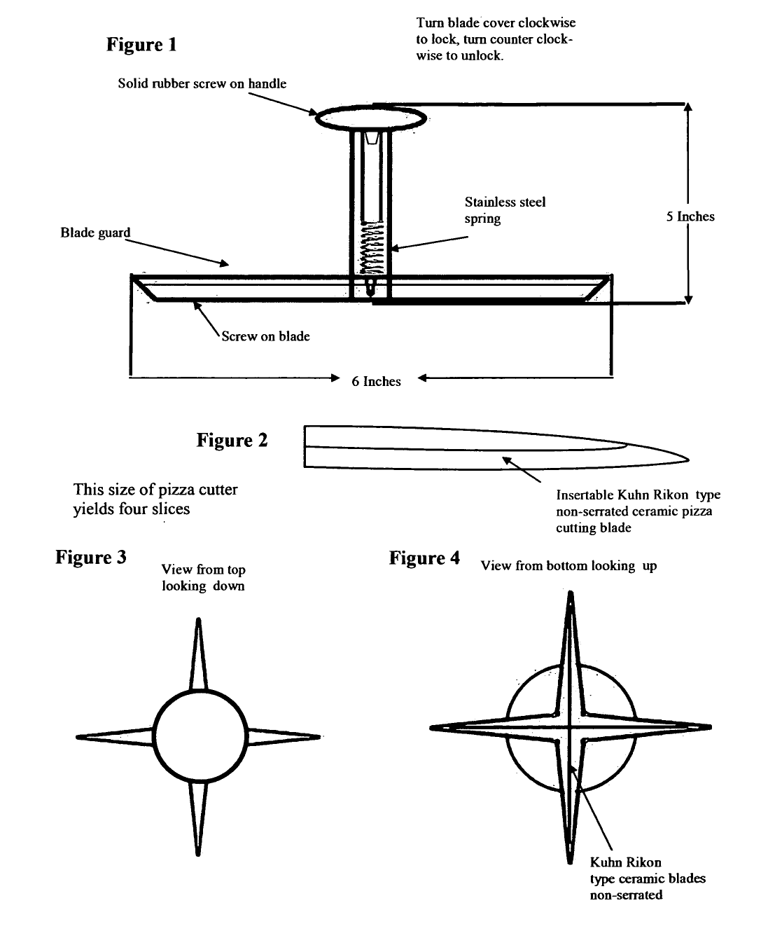

This invention provides an improved method of rapidly and quickly cutting pizza into anywhere from 4 to 12 slices. The tube contains a spring that immediately retracts the blades back into the blade guards once they have cut the pizza into the number of slices for which the specific model and size is designed to produce. Each model is equipped with Kuhn Rikon type non serrated ceramic blades. The blades come down out of the metal blade guard. With this device cutting pizzas into anywhere from 4 to 12 slices is as simple as pushing down on the handle, and then letting go of the handle. The pizza is instantly cut into equally sized slices. The most important difference between using a MULTI-SLICE PIZZA CUTTER to cut the pizza as opposed to a normal knife or blade wheel is that all it takes is a push of the handle, and almost instantly, it is done, whereas with a knife or blade wheel, it could take a minute or two longer. One or two minutes in a restaurant during a busy rush hour always makes a significant difference in quickly serving and satisfying customers.

Pizza cutters have long been known and widely used. Pizza cutters of various types go back at least to the turn of the twentieth century and have usually taken the form of a specially shaped knife or a blade wheel. The blade wheel is usually attached to a plastic or wooden handle and is passed over the pizza, in order to cut the pizza as it rotates. Some remotely similar inventions can be found in the following patents:
2009901519 Cornelio Lorenzo Formentin
2008901875 Cornelio Lorenzo Formentin
2008901874 Cornelio Lorenzo Formentin

The MULTI-SLICE PIZZA CUTTER is a tool to cut multiple pizza slices simultaneously in order to reduce pizza slice cutting time.

The MULTI-SLICE PIZZA CUTTER can be used in pizzerias, restaurants, and it can also be used at home.

Pizza cutters have long been known and widely used Pizza cutters of various types go back at least to the turn of the twentieth century and have usually taken the form of a specially shaped knife or a blade wheel. The blade wheel is usually attached to a plastic or wooden handle and is passed over the pizza, in order to cut the pizza as it rotates. Some remotely similar inventions can be found in the following patents: Though such pizza cutting and slicing devices have achieved considerable popularity and commercial success, there has been a continuing need for improvement. Other applications for patents for similar devices have lapsed. The ones that have not lapsed are for very different kinds of devices. Attached herewith are the drawings included with this application.

2009901519 Cornelio Lorenzo Formentin

2008901875 Cornelio Lorenzo Formentin

2008901874 Cornelio Lorenzo Formentin

2003906245 Ian David Mitchell

All of the above applications for a patent on a similar invention have lapsed.

20080289189 Puzant Khatchadourian

This is for an application for a patent for a somewhat similar device.

20100313432 Ty Caswell

This is for an application for a patent for a device similar to a rotating blade pizza cutter, but with two blade wheels. Though such pizza cutting and slicing devices have achieved considerable popularity and commercial success, there has been a continuing need for improvement. Other applications for patents for similar devices have lapsed. The ones that have not lapsed are for very different kinds of devices.

Although five (5) such drawings are attached, they are for the different sizes of pizza cutter, varying for the size of pizza and number of slices for which each model is intended. They are all for a singular patent application, NOT for multiple patents.

1. I claim to have invented a tool to cut multiple pizza slices simultaneously in order to reduce pizza slice cutting time.
The MULTI-SLICE PIZZA CUTTER consists of a handle mounted on top of the apparatus that when pushed down compresses a stainless steel spring, causing the non serrated ceramic blades to lower and cut the pizza into equally sized slices. Upon releasing the handle, the spring causes the blades to retract into the metal blade guards. This greatly reduces the time required to slice pizza.
